(19) United States
(12) Patent Application Publication
(10) Pub. No.: US 2005/0214412 A1
(43) Pub. Date: Sep. 29, 2005

(54) APPARATUS AND METHOD FOR DELIVERING NUTRITIONAL SUPPLEMENTS WITH BEVERAGE SWEETENERS

(76) Inventors: Jason Koo, Orlando, FL (US); Charly R. Barnum, Winter Garden, FL (US); Seth Elsheimer, Orlando, FL (US)

Correspondence Address: JOHN C. SMITH, ESQ., 2499 GLADES ROAD, SUITE 113, BOCA RATON, FL, 33431, US

(21) Appl. No.: 10/907,263

(22) Filed: Mar. 25, 2005

Related U.S. Application Data
(60) Provisional application No. 60/521,287, filed on Mar. 26, 2004.

(51) Int. Cl. A23K 1/175

(52) U.S. Cl. 426/74

(57) ABSTRACT

A prepackaged sweetener packet containing one or more nutritional supplements. The nutritional supplements can be in the form of dry powders or granular material that is dispersed throughout the sweetener, which dissolves when mixed with a beverage. Another optional multi-chamber packet separates the sweetener from the nutritional supplement during storage. When the packet is opened for use with a beverage, both the sweetener and the nutritional supplements can be simultaneously poured into the beverage. A conventional paper structure can be used for dry sweeteners and nutritional supplements, or the water impermeable material can be used to store moist or liquid sweeteners and nutritional supplements.

### CROSS-REFERENCE TO RELATED APPLICATIONS

This application is related to, and claims the benefit of, the provisional patent application entitled “Apparatus And Method For Delivering Nutritional Supplements With Beverage Sweeteners”, filed Mar. 26, 2004, bearing U.S. Ser. No. 60/521,287 and naming Jason Koo, one of the named inventors herein, as sole inventor, the contents of which is specifically incorporated by reference herein in its entirety.

### BACKGROUND OF THE INVENTION

1. Technical Field

The present invention relates to nutritional products. In particular, it relates to a method of delivering nutritional supplements, such as vitamins, minerals and/or natural herbs in combination with powdered sweeteners used for beverages.

2. Background Art

The prior art has produced several liquid beverages containing additives for nutritional purposes. These beverages typically are fortified with vitamins such as vitamin C, minerals such as calcium, etc. This combination provides users of prepackaged beverages with the convenience of obtaining nutritional supplements at the same time that they simply enjoy the beverage.

In the case of beverages which are prepared by the user, and not prepackaged, the user adds and mixes the appropriate ingredients to adjust the flavor and sweetness of the beverage. Originally, sweeteners such as sugar or honey were used. As consumers began obtaining and transporting sweeteners, or preparing beverages at restaurants, a variety of sweeteners were prepackaged to allow an individual to conveniently mix an appropriate amount of sweetener in a beverage. A popular method of packaging sweeteners, such as sugar, has been to place them in a small paper packet which contains approximately a teaspoon of sugar.

In addition to sugar, a variety of other powdered or granular sweeteners have been created for the purpose of sweetening beverages. These sweeteners are also distributed in the same type of packet structure used for sugar due to its convenience. Several types of sweetener are available. They can be artificially developed chemical compounds, such as saccharin, Aspartame, etc., or naturally occurring sweeteners, such as the herb Stevia, etc. These compounds are typically distributed in small packets that contain the equivalent sweetening value of approximately one teaspoon of sugar.

A significant drawback to prior art sweetener packet systems is that they limit themselves to the sole function of providing sweeteners. It would be desirable to provide additional benefits and convenience to users, such as providing nutritional benefits along with sweeteners to allow individuals to gain some health benefits while preparing beverages.

To date, the prior art has not provided a method of delivering nutritional supplements in combination with powdered or granular sweeteners, such as those discussed above, which also contain one or more nutritional supplements. It would be advantageous to have a method of distributing nutritional supplements in combination with powdered sweeteners in conventional packages typically found in restaurants, etc.

### SUMMARY OF THE INVENTION

The present invention provides a prepackaged sweetener which contains one or more nutritional supplements, in addition to the sweetener. The nutritional supplements can be in the form of dry powders or granular material that is dispersed throughout the sweetener, and which dissolves when mixed with a beverage.

An alternative embodiment uses nutritional supplements that are micro-encapsulated to extend their shelf life and protect them from possible alteration due to chemical interaction with the sweetening substance. The micro-encapsulation provides a dissolvable outer shell which protects the nutritional supplements while they are being stored and dissolves when mixed in the beverage to release the nutritional supplements therein.

Another alternative embodiment provides a multi-chamber packet that separates the sweetener from the nutritional supplement during storage. When the packet is opened for use with a beverage, both the sweetener and the nutritional supplements can be simultaneously poured into the beverage. This packaging method gives the consumer some options regarding how the contents of the package will be used. For example, the user can open the sugar portion and used that as a conventional portion of sugar. Likewise, the user can open only the vitamin/mineral portion of the packet and use it. Of course, the more common use would be to open and use the contents of both sides of the package at the same time.

In an alternative embodiment, the sweetener and nutritional supplements are stored in other containers, such as directly in the tea bags, single coffee pods, or any other prepackaged dosage items for these or other beverages. This provides a system in which the use of the nutritional supplements in combination with beverage sweeteners is entirely transparent to the user.

The embodiments provided by the invention allow vitamin/minerals to be consumed by the user without requiring reminders, or a conscious decision, to take needed vitamins/minerals.

### BRIEF DESCRIPTION OF THE DRAWINGS

FIG. 1 illustrates a prior art sweetener packet that contains powdered or granular sweetener.

FIG. 2 illustrates a preferred embodiment of the invention which shows nutritional supplements intermixed with sweetener inside a conventional sweetener packet.

FIG. 3 illustrates another preferred embodiment of the invention which shows micro-encapsulated nutritional supplements intermixed with sweetener inside a conventional sweetener packet.

FIG. 4 illustrates a further preferred embodiment that illustrates a dual chamber packet in which sweetener is stored in a first compartment and nutritional supplements are stored in a second compartment.

FIG. 5 illustrates yet another alternative embodiment in which a multi-chamber packet is used to separately store multiple nutritional supplements, in combination with sweetener stored in a separate compartment.

### DESCRIPTION OF THE PREFERRED EMBODIMENT

Prior to a detailed discussion of the figures, a general overview of the invention will be presented. This invention provides an apparatus and method for delivering nutritional supplements in combination with sweetener such that the nutritional supplements can be automatically supplied to an individual while the individual is preparing a beverage. In addition, it provides a method of protecting various nutritional supplements from external environmental factors while the packet containing the sweetener and nutritional supplements is being stored.

The simplest preferred embodiment of the invention provides a conventional sweetener packet in which the sweetener is mixed with powdered nutritional supplements in a single chamber packet.

Another alternative preferred embodiment uses a dual chamber packet which separates the sweetener from the nutritional supplements. The packet is opened in the same manner as a prior art sweetener packet. When the contents of the two chambers are emptied into a beverage they dissolve into the beverage.

Yet another alternative embodiment provides a multi-chamber packet in which one or more nutritional supplements may be individually stored, or stored in combination with the sweetener. As was the case above, this packet is also opened and emptied into the beverage in the same manner.

The material used to fabricate the packet may be paper as used by conventional sweetener packets. Likewise, the packet may be constructed from leakproof material that will allow either dry or moist nutritional supplements to be stored prior to use.

Those skilled in the art will recognize that depending on the type of nutritional supplement used, more or less sweetener may be used. For example, a nutritional supplement may have a bitter taste. Therefore, it may be desirable to add additional sweetener to compensate for the taste characteristics of a particular nutritional supplement.

Another important aspect of the invention is the appearance of the vitamin/mineral sweetener. In particular, it is important to have a homogenous appearance for the user. In order to ensure that an homogeneous appearance is provided by the vitamin/mineral sweetener, several methods can be used, as follows:

1. The solids can be ground together mixed thoroughly to create an homogeneous white solid powder.

2. The selected components can be co-dissolved in the proper ratio in a solvent (e.g., water or other suitable liquid), then the solvent can be rotary evaporated to leave co-precipitated solid. The vitamin/mineral sweetener can also be subsequently ground to a predetermined particle size.

3. Particle uniformity and size can be easily controlled with known spray-drying techniques. However, this processing technique is more expensive both in terms of equipment and energy.

Those skilled in the art will recognize that the individual doses selected for vitamins, minerals and sweetener may vary. Preferably, the amount of sweeteners selected should provide substantially the same sweetening effect as a conventional packet of sugar or artificial sweetener. In regard to the vitamins and/or minerals selected for a particular vitamin/mineral sweetener combination, the amounts of vitamins and/or minerals selected should be sufficient to provide nutritional value to the user, based on minimum daily requirements as established by the government. However, as a practical matter individuals tend to have more than one beverage per day. Further, some individuals may use a single packet of sweetener, while others may use two or more. As a result, the percentage of minimum daily requirements would preferably be less than 100 percent for any given vitamin or mineral, but should be at a high enough level that provides the nutritional benefit to the user. In short, the amount of vitamin/minerals in each packet should take into account the likelihood of multiple beverage consumption plus the nutritional benefit of food taken during the course of a day.

Experimental Methods

The following experimental tests were made in regard to the combination of vitamin C and various sweeteners. Those skilled in the art will recognize that the same methodology can be used for any other vitamin or mineral to test the performance and effectiveness of the resulting product.

The following data lists the experimental methods used to determine the proper method of manufacturing the product using vitamin C and sweeteners:

a) Solubility Tests

Commercial samples of the artificial sweeteners were used. The sugar used was from commercially available packets of Diamond Crystal Brands, Inc. Vitamin C and calcium ascorbate dihydrate (99%) were commercial samples obtained from Aldrich Chemical Company. A “standard” solubility test based on rate rather than amount of material dissolvable was developed for this study. Since all the materials dissolve quickly and completely under normal application conditions, the test method was intentionally designed to create more difficult conditions than a consumer would normally encounter. This had the advantage of lengthening the time required for dissolution and making measurements more reliable. The standard method consists of placing 20-mL of solvent (water, tea, or coffee) in a wide-mouth jar and placing that on a Fisher Scientific “Isotemp” combination stirring hot plate. A thermometer was mounted above the apparatus such that it could be inserted into the test vessel at will. A 1-inch×0.25 inch teflon-coated stirring magnet was placed in the test vessel and set spinning at 300 rpm. Most tests were carried out at ambient temperature, but hot and cold experiments were carried out by heating the stirred solution on the hotplate or pre-cooling the sample and apparatus in an ice/water bath, respectively. The solid sample was added all in one portion to the stirred liquid while simultaneously starting a timer. Timing continued until the solution returned to the same clarity as the original solvent and essentially no un-dissolved solid could be seen. While normally chemists use distilled or deionized water for experiments on aqueous systems, tap water was used for all pH and solubility tests in this study in order to more closely simulate application conditions. Some solubility samples of solid were ground with mortar and pestle to a fine dust prior to dissolution for comparison to similar un-ground granular samples.

b) pH Measurements

All pH measurements were carried out on the same solutions that were obtained from solubility tests when possible. A recently calibrated Corning 320 pH meter was used. Duplicate measurements were carried out randomly as a check on reproducibility.

c) Taste Tests

Aqueous solutions of vitamin C (1.00 g+/−0.01 g) combined with sweetener (1.02 g+/−0.01 g) were prepared in 20 mL of water. Samples containing only vitamin C and only calcium ascorbate were also prepared. Each solution was taste tested by inserting the tip of a clean stainless steel spoon in the solution and transferring a couple drops of solution onto the tongue. At least one tasting was done for each sample but duplicate tests were done if any clarification was needed.

d) Proton Nuclear Magnetic Resonance (NMR) Spectroscopy

All ¹H NMR spectra were obtained on a Varian Mercury 300 NMR spectrometer operating at ambient temperature. Solutions were prepared in deuterium oxide solvent (isotopically labeled water). Samples were prepared by dissolving a measured amount of solid in sufficient solvent to produce a total volume of approximately 1 mL. Initial samples were prepared just before spectra were obtained in order to minimize possible premature hydrolysis or attack by microbes in the case of sugar solutions. Samples were later re-examined after heating at 70.0 to 92.0° C. (158 to 198° F.) for 98 minutes and then again after being stored outside on the roof exposed to Central Florida sunlight and heat for 47.3 hours.

Experimental Results

The following data lists the results of the experiments used to determine the proper method of manufacturing the product:

a) Solubility and pH

As shown in Table 1, all materials tested showed good to excellent aqueous solubility. Solubility rates generally increase with temperature (Samples 4 and 17; 11 and 20; 5 and 18; 6 and 22; 13 and 16; 12 and 21; 26, 27 and 28). Solubility increases somewhat with particle size (Samples 13 and 14; 11 and 15). At room temperature the solubility rate of vitamin C is approximately the same in water and strong coffee (Samples 15 and 26).

TABLE 1
Solubility Rate and pH Measured Under Standard Conditions

| Sample No. and Description | Temp (C°) | Time (min:sec) | pH |
|---|---|---|---|
| 1. Deionized water | 23.5 | | 4.7 |
| 2. Tap water | 23.5 | | 7.69 |
| 3. Packet of sugar (2.78 g) | 23.5 | 1:50 | 7.84 |
| 4. Equal ™ (1.01 g) | 23.5 | 1:33 | 6.68 |
| 5. Sweet'N Low ™ (1.17 g) | 23.5 | 1:40* | 7.06 |
| 6. Splenda ™ (1.03 g) | 23.5 | 1:28 | 7.71 |
| 7. Vit. C (1.00 g) in solution | 23.5 | 1:45 | 2.60 |
| from sample 3 | | | |
| 8. Vit. C (0.99 g) in solution | 23.5 | 1:15 | 2.74 |
| from sample 4 | | | |
| 9. Vit C (1.01 g) in solution | 23.5 | 1:42 | 2.70 |
| from sample 5 | | | |
| 10. Vit C (1.01 g) in solution | 23.5 | 1:16 | 2.63 |
| from sample 6 | | | |
| 11. Vit. C (1.01 g) in tap water | 23.5 | 1:20 | 2.62 |
| 12. Calcium ascorbate dihydrate^{#} | 23.5 | 0:35 | 7.38 |
| (1.02 g) | | | |
| 13. Sugar (1.02 g) | 23.5 | 1:04 | 7.78 |
| 14. Sugar (1.02 g, ground) | 23.5 | 0:58 | |
| 15. Vit. C (1.01 g, ground) | 23.5 | 0:50 | |
| 16. Sugar (1.03 g) | 3.5-9.0 | 6.36 | |
| 17. Equal ™ (0.99 g) | 3.5-4.0 | 2:08 | |
| 18. Sweet'N Low ™ (1.04 g) | 3.2-3.6 | 1:53* | |
| 19. Splenda ™ (0.85 g, Bulk***) | 3.0-3.2 | 1:01 | |
| 20. Vit. C (1.03 g) | 3.0-6.5 | 6:28 | |
| 21. Calcium ascorbate | 2.5-2.9 | 2:14 | |
| dihydrate (1.00 g)**** | | | |
| 22. Splenda (1.02 g, packet) | 2.5-2.8 | 1:56 | |
| 23. Strong brewed tea | 23.5 | | 5.98 |
| 24. Vit. C (1.02 g) in strong tea | 1.0-3.0 | 3:20** | 2.78 |
| 25. Strong coffee | 25.0 | | 5.32 |
| 26. Vit. C (1.02 g, ground) | 25.0 | 0.52 | 2.92 |
| in strong coffee | | | |
| 27. Vit. C (0.99 g, ground) | 75.2-74.0 | 0.28 | |
| in strong coffee | | | |
| 28. Vit. C (1.01 g, ground) | 1.5-5.2 | 0.52 | |
| in strong coffee | | | |

*Samples of Sweet'N Low™ (5 and 18) showed some slight cloudiness after solubility tests. Apparently the calcium silicate or cream of tartar contained in that product formulation is less soluble than the other components. Eventually the solutions cleared but the slight cloudiness persisted for several hours. ** The solubility rate test in cold strong tea (Sample 24) was difficult to accurately measure due to the persistent cloudiness and dark color of the solution. Cold tea is normally more cloudy than tea at room temperature.

*** Splenda™ sold in bulk for cooking and baking shows different (faster) solubility than the analogous material sold in packets for tabletop applications. The formulations are identical but the manufacturing process imparts more air into the bulk material making it about ⅙ as dense as the packet material. When the two materials were inspected under a microscope at 10× magnification it was clear that the spray drying process left bubbles in the bulk material. These appear as rounded shiny portions. Those bubbles are far less prevalent in the packet material.

**** After standing for about 20 hours at room temperature all the solubility test sample appeared as clear colorless solutions except that the samples containing calcium ascorbate dihydrate (samples 12 and 21) which had a khaki tint and some cloudiness. This may be due to impurities in the 99% material used.

In a separate experiment solid samples of crystalline sucrose and crystalline vitamin C were ground together with a mortar and pestle. The resulting white solid dust was well-behaved and nearly free-flowing. It appeared homogenous to the naked eye. This grinding may be able to replace the common spray drying technique as a manufacturing technique.

b) Taste Tests

TABLE 2
Taste Tests for solutions of Vitamin C Alone or with Sweetener

| Sample Description | Taste Description |
|---|---|
| 1.01 g Vit. C in 20 mL water | Sour, dissipates quickly, no aftertaste |
| 1.00 g Vit. C + 1.02 g Sugar | Slightly less sour than vit. C alone; |
| in 20 mL water | Vaguely sweet undertaste short-lived |
| 0.99 g Vit. C + 1.01 g Equal | Sweetness dominant here but barely; |
| in 20 mL water | Sour undertaste apparent |
| 1.01 g Vit. C + 1.01 g Sweet'N | Sweetness definitely dominant; |
| Low in 20 mL water | Sour undertaste still detectable |
| 1.01 g Vit. C + 1.03 g Splenda | Approximately the same as above |
| 1.02 g Calcium ascorbate dihydrate | Subtle flavor if any; Repeated 3X |
| in 20 mL water | No sourness or sweetness detected; |
| | Possibly a very mild salty flavor |

in 20 mL water

c) Proton NMR Spectroscopy

Sample Number and Description
1) 0.15 g Vitamin C+0.16 g Sugar
2) 0.14 g Vitamin C+0.14 g Equal™
3) 0.14 g Vitamin C+0.14 g Sweet'N Low™
4) 0.14 g Vitamin C+0.14 g Splenda™
5) 0.16 g Vitamin C
6) 0.14 g Sugar
7) 0.18 g Equal™
8) 0.15 g Sweet'N Low™
9) 0.17 g Splenda™
10) Blank (deuterium oxide solvent only; a control sample)

There were a few small changes in the spectra before and after heating the samples at 70-92° C. for 98 minutes. Some small new signals emerged in samples 1 and 9. The relative intensities of a few signals changed slightly in samples 2-5 and 7-8. All samples appeared virtually identical by NMR before and after 47.3 hours of exposure to Central Florida weather conditions of heat and sunlight. Vitamin C-containing samples were also consistent with a published literature spectrum of Vitamin C (Aldrich Library of ¹³C and ¹H NMR Spectra).

Experimental Conclusions

1. Vitamin C is chemically compatible with table sugar or any of the commercially formulated artificial sweeteners Equal,™ Sweet'N Low,™ and Splenda.™

2. Possible formulations can be considered using any of the materials tested. All components show good or excellent solubility characteristics in water, tea, and coffee over a wide range of reasonable hot and cold beverage temperatures. Solubility rates vary slightly with particle size and significantly with temperature. The differences are not important relative to the general ease of solubility.

3. All components in this study are either stable to hydrolysis, heat, and light or decompose only slightly by pathways resembling normal human metabolism when heated. The products can be considered safe for human consumption. No photochemical decomposition was observed for any samples in solution after 2 days exposure to sunlight.

4. Generally, the presence of vitamin C lowers the pH of a resulting solution. Since hydrolysis of some components is acid-catalyzed, vitamin C may accelerate hydrolysis slightly, but without harm to the consumer or the product.

5. Vitamin C imparts a sour taste to aqueous solutions. All sweeteners studied mask the sourness with varying effectiveness.

6. Calcium ascorbate dihydrate should be further considered as a source of vitamin C. It has excellent solubility and provides calcium. It is also on the GRAS (Generally Regarded As Safe) list of food additives and has very little taste compared to vitamin C. Those advantages may be offset by cost and some discoloration in solution.

7. The components can be processed to a solid of homogeneous appearance by grinding or milling the solids together or spray drying solutions of component mixtures.

In addition to the foregoing, the granulated vitamin/mineral supplement uses mineral salts of vitamins which have greater aqueous solubility, and reduce or eliminate sour or otherwise unpleasant tastes. Likewise, the vitamin C can be calcium ascorbate dihydrate mixed with a sweetener from the group comprising: aspartame, sucralose, saccharine, or a salt of saccharin.

The nutritional supplement may use a solid filler-binder from the group consisting of dextrose, and/or maltodextrin; and/or prebiotics, such as fructooligosaccharides and/or galactooligosaccharides. The nutritional supplement may include a trace of anti-caking agent such as calcium silicate.

Any number of vitamin/minerals may be used, alone or in combination, including ascorbic acid (vitamin C), tiamin (vitamin B1), riboflavin (vitamin B2), pyridoxine (vitamin B6), niacin, folic acid (vitamin M), vitamin B12, pantothenic acid, biotin (vitamin H), vitamin A, vitamin D, vitamin E, and/or vitamin K.

Preferably, the minerals are delivered in ionic form and are in the group comprising calcium, chromium, copper, iron, magnesium, and/or zinc.

Having discussed the features and advantages of the invention in general, we now turn to a more detailed discussion of the figures.

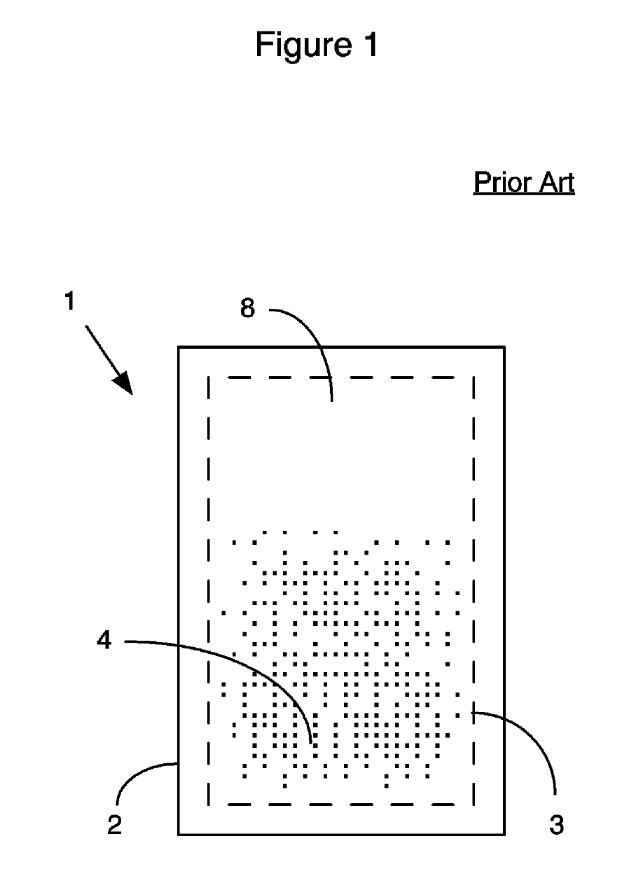

FIG. 1 illustrates a prior art sweetener packet 1 that contains powdered or granular sweetener 4. The packet 1 has an outer shell 2 with an inner chamber 8 that is defined by dashed lines 3. The inner chamber 8 provides storage space for sweetener 4. These packets 1 are normally torn open prior to use so that the contents may be poured into a beverage where it dissolves.

Those skilled in the art will recognize that the structure of packet 1 can be used with any type of sweetener 4. The sweetener 4 can be anything suitable for its purpose, such as natural sweeteners 4 like sugar or the herb Stevia. Likewise, the sweetener 4 can be a synthetic sweetener 4 such as saccharin or aspartame, or artificial sweeteners commonly available under a variety of trademarks such as Equal™, Sweet'N Low™, or Splenda™. Artificial sweeteners, of course, benefit not only individuals who are dieting, but also individuals who have medical disabilities, such as diabetes.

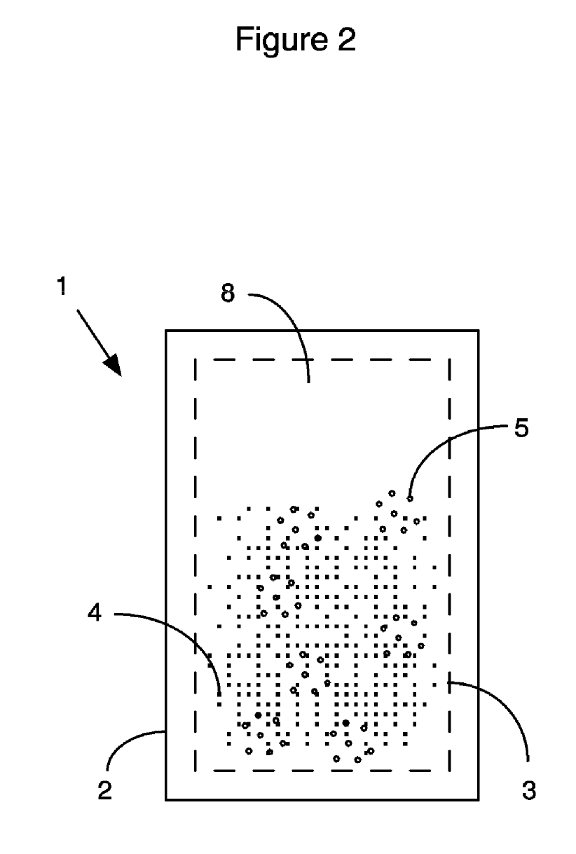

FIG. 2 illustrates a preferred embodiment of the invention which shows nutritional supplements 5 intermixed with sweetener 4 inside a conventional sweetener packet 1. This embodiment is the simplest form of the invention. It uses powdered nutritional supplements 5, such as vitamins or minerals which can be manufactured or prepared in powdered form. In this embodiment, the nutritional supplements 5 are simply mixed in with the powdered or granulated sweetener 4 and used in the same manner as prior art sweetener 4 packets 1. This is effective in situations where the nutritional supplement 5 will not interact chemically with the particular type of sweetener 4 that is being used.

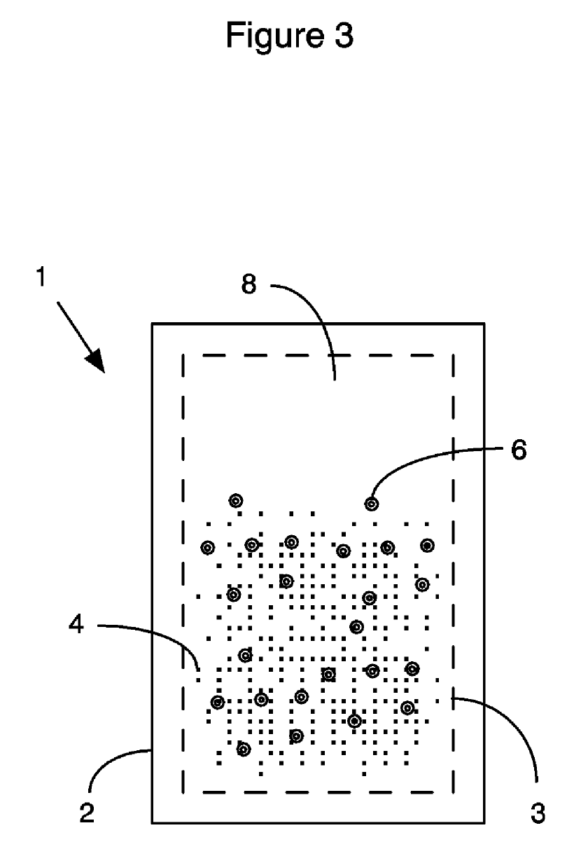

FIG. 3 illustrates another preferred embodiment of the invention which shows micro-encapsulated nutritional supplements 6 intermixed with sweetener 4 inside a conventional sweetener 4 packet 1. Those skilled in the art will recognize that some types of vitamins or nutritional supplements 5 may have a short shelf life when exposed to environmental factors, or be susceptible to chemical interaction with the particular sweetener 4 being used. By using micro-encapsulated nutritional supplements 6, they can be protected from both environmental factors, and/or chemical interaction with the sweetener 4. As a result, the micro-encapsulation process provides a sweetener/nutritional supplement delivery system that has a longer shelf life, and which also is capable of storing the sweetener 4 and the nutritional supplement 5 in the same inner chamber 8.

Those skilled in the art will recognize that alternative methods of protecting the contents of the packet 1 from environmental factors are available. In particular, while prior art sweetener 4 packets 1 are typically fabricated from paper, alternative pack material may be used to prevent damage from environmental factors. For example, the packet 1 material may be impervious to water or humidity so that any nutritional supplements 5, 6 would be kept properly dry during storage. Of course, such packets 1 may also be fabricated such that they shield the packet 1 contents from light, since the nutritional supplements 5 may have chemical compounds are adversely affected by light. Those skilled in the art will recognize that if packet 1 is designed to protect the contents from light or water can be fabricated from a single material, or can be implemented using a conventional outer paper shell or with an inner liner, etc.

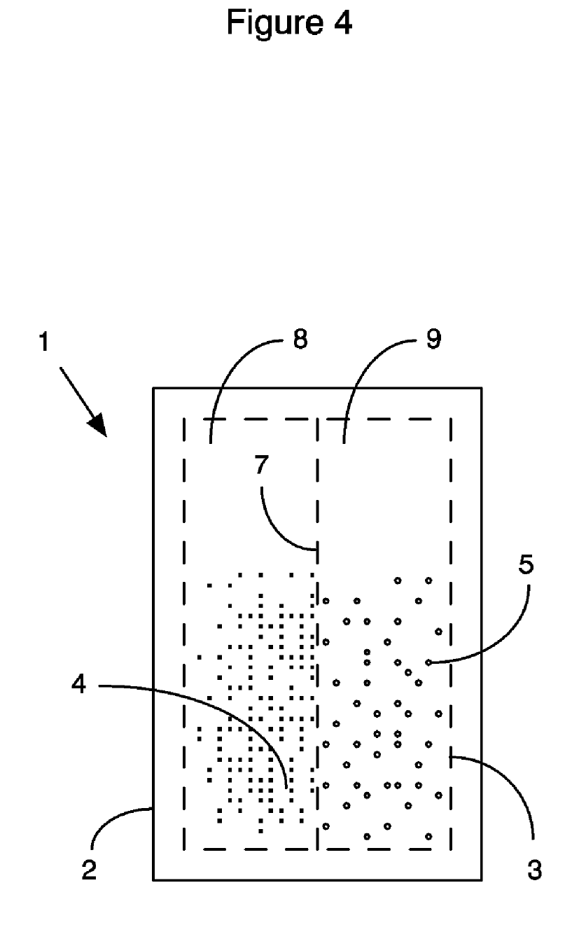

FIG. 4 illustrates a further preferred embodiment that has a dual chamber packet 1 in which sweetener 4 is stored in a first inner chamber 8 and nutritional supplements 5 are stored in a second inner chamber 9. The first and second inner chambers 8-9 are defined by a central seal line 7 which separates the two inner chambers 8-9 of the packet 1. An advantage provided by this embodiment is that it allows the packet 1 to store sweetener 4 and nutritional supplements 5 in separate inner chambers 8-9, thereby avoiding the situation in which the sweetener 4 and the nutritional supplements 5 might chemically react with one another if mixed within the same inner chamber 8 prior to use. In addition, those skilled in the art will recognize that if the inner chambers 8-9 of packet 1 are impermeable, then dry powdered sweetener 4 can even be safely stored with moist or liquid nutritional supplements 5, or vice versa.

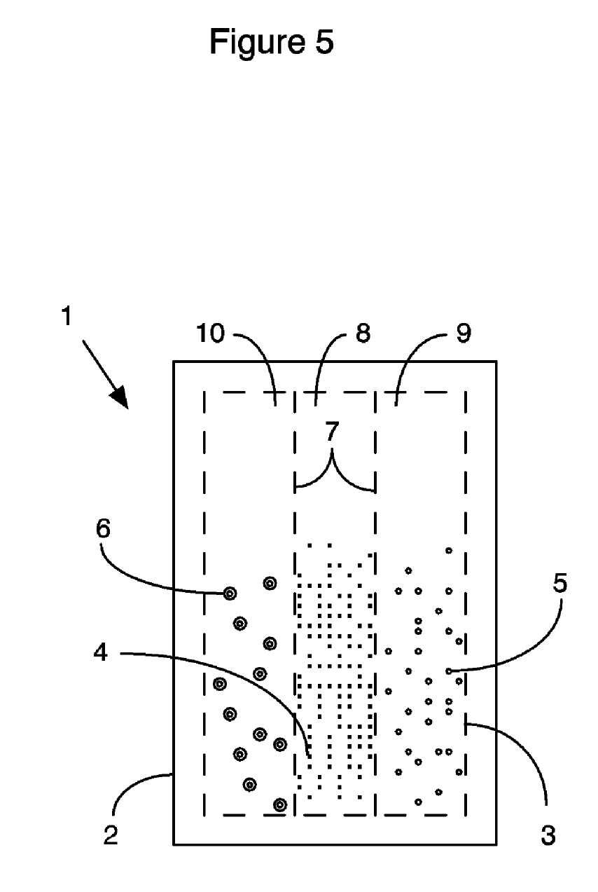

FIG. 5 illustrates yet another alternative embodiment in which a multi-chamber packet 1 is used to separately store multiple nutritional supplements 5, 6 in combination with sweetener 4. In this figure, each individual ingredient is stored in a separate inner chamber 8-10 that is defined by inner seal lines 7.

As can be seen from the foregoing, a variety of methods can be used to store nutritional supplements 5, 6 in the same packet 1 as sweetener 4. It provides an individual the benefit of automatically receiving nutritional supplements 5, 6 without having to remember to take any specific action. A variety of methods have been shown to protect nutritional supplements 5, 6 prior to use, including the use of micro-encapsulation, segregation of one or more nutritional supplements 5, 6 from the sweetener 4, or each other, via separate storage compartments, such as inner chambers 8-10. Also disclosed is the use of alternative packet 1 materials to provide packets that are resistant or impermeable to water, humidity, or other liquids or vapors. As a result, if packet 1 is impermeable to water, and has a plurality of internal storage compartments, it will allow nutritional supplements 5, 6 to be stored not only as a dry powder or granular material, but also has a moist or liquid material. Further, by sealing the inner chambers 8-10 such that they are impermeable liquids, the invention also allows one or more inner chambers 8, 9 or 10 to store dry material while the remaining inner chambers 8, 9 for 10 to store moist or liquid material.

Those skilled in the art will also recognize that the packet 1 structure disclosed herein also allows both liquid sweetener 4, and liquid nutritional supplements 5, 6 to be simultaneously used, providing that the packet 1 is impermeable to liquids.

Those skilled in the art will recognize that depending on the type of nutritional supplement 5 used, that nutritional supplement 5 may naturally have a taste which may be more or less bitter. Likewise, some nutritional supplements 5 may have a taste which is naturally sweet. As a result, it is intended that depending on the nature of the nutritional supplement 5 which is being included in packet 1, the total amount of sweetener 4 that is inserted into packet 1 will vary such that any bitter taste created by nutritional supplements 5 will be masked by the addition of extra sweetener 4. Likewise, if the nutritional supplements 5 are naturally sweet, then the amount of sweetener 4 inserted into packet 1 can be reduced.

For ease of illustration, the previous embodiments were discussed in terms of a sweetener and vitamin/mineral nutritional supplement being used with beverages. However, those skilled in the art will recognize that the benefits of the invention can be realized when using the packet in other ways. For example, the sweetener and vitamin/mineral combination can be used to sweeten foods other than beverages, such as a bowl of cold cereal or fruit. When an individual has a bowl of cereal, the sweetener and vitamin/mineral combination can replace the table sugar which someone may pour on top of a bowl of cereal.

While the invention has been described with respect to a preferred embodiment thereof, it will be understood by those skilled in the art that various changes in detail may be made therein without departing from the spirit, scope, and teaching of the invention.

We claim:

1. A sweetener and vitamin/mineral nutritional supplement delivery system for beverages, further comprising:
a packet defining at least one interior storage chamber;
at least one type of powder or granulated sweetener; and
at least one type of powder or granulated vitamin/mineral supplement;
whereby the nutritional supplement is stored within the packet and dispensed into a beverage when the sweetener is added to the beverage.

2. A system, as in claim 1, wherein the granulated vitamin/mineral supplement uses mineral salts of vitamins;
whereby, the nutritional supplement has greater aqueous solubility, and reduces or eliminates sour or otherwise unpleasant tastes.

3. A system, as in claim 1, wherein the vitamin is calcium ascorbate dihydrate mixed with a sweetener from the group comprising: aspartame, sucralose, saccharine, or a salt of saccharin.

4. A system, as in claim 1, wherein the nutritional supplement further comprises:
a solid filler-binder from the group consisting of dextrose, and/or maltodextrin; and/or
prebiotics, from the group consisting of fructooligosaccharides and/or galactooligosaccharides.

5. A system, as in claim 1, wherein the nutritional supplement further comprises:
aspartame, sucralose, saccharine, a salt of saccharin, or sucrose.

6. A system, as in claim 1, wherein the nutritional supplement further comprises
a trace of anti-caking agent.

7. A system, as in claim 6, wherein the anti-caking agent is calcium silicate.

8. A system, as in claim 1, wherein:
at least one of the vitamin/minerals is from the group comprising: ascorbic acid (vitamin C), tiamin (vitamin B1), riboflavin (vitamin B2), pyridoxine (vitamin B6), niacin, folic acid (vitamin M), vitamin B12, pantothenic acid, biotin (vitamin H), vitamin A, vitamin D, vitamin E, vitamin K.

9. A system, as in claim 8, wherein:
the minerals are delivered in ionic form and are in the group comprising calcium, chromium, copper, iron, magnesium, and/or zinc.
